(19) United States
(12) Patent Application Publication
(10) Pub. No.: US 2016/0255482 A1
(43) Pub. Date: Sep. 1, 2016

(54) APPARATUS AND METHOD TO FACILITATE DOWNLOADING MOBILE SOFTWARE APPLICATIONS INTO A PORTABLE ELECTRONIC DEVICE, WHICH SOFTWARE APPLICATIONS INCLUDE ADVERTISEMENTS THAT ARE EMBEDDED WITHIN THE SOFTWARE APPLICATION AND ARE RE-TRANSMITTED TO OTHERS THROUGH USE OF THE PORTABLE ELECTRONIC DEVICE

(71) Applicant: Slamad.com, Inc., Deer Park, NY (US)

(72) Inventors: Steven Brown, Oyster Bay Cove, NY (US); Leonard Butterman, Merrick, NY (US); Anthony Pisciotto, JR., Huntington, NY (US)

(21) Appl. No.: 15/148,846

(22) Filed: May 6, 2016

Related U.S. Application Data
(63) Continuation of application No. 14/572,404, filed on Dec. 16, 2014.
(60) Provisional application No. 61/922,848, filed on Jan. 1, 2014.

(51) Int. Cl. H04W 4/14; H04L 29/08; H04L 12/26; G06Q 30/02

(52) U.S. Cl. CPC H04W 4/14; G06Q 30/0267; H04L 67/34; H04L 43/065

(57) ABSTRACT

An apparatus and method to facilitate downloading mobile software applications into a portable electronic device, which software applications includes advertisements that are embedded within the software application and are re-transmitted to others through use of the portable electronic device. The software application transforms an ordinary text message into a source of advertising. The software application directs the advertisement to a specific focus group and the software application utilizes a portable electronic device to transform the advertisement into an advertisement transmitted when the portable electronic device communicates with another portable electronic device, which transmission includes text messages that include the advertisement therein.

### CROSS-REFERENCE TO RELATED APPLICATION

This application is a continuation of, and claims priority to U.S. Non-Provisional application Ser. No. 14/572,404, filed on Dec. 16, 2014, which claims the benefit of Provisional Application No. 61/922,848 filed on Jan. 1, 2014, each of which are incorporated herein by reference in their entirety.

### BACKGROUND OF THE INVENTION

1. Field of the Invention

The present invention relates to the field of mobile software applications which are downloadable to electronic devices and can be transmitted from the electronic devices to other electronic devices. The present invention also relates to the field of providing advertising services for others to facilitate advertising products and services and compensating users for facilitating transmitting the advertising to others through the interaction of their electronic devices with other electronic devices.

2. Description of the Prior Art

The following 9 patents and published patent applications are known to the inventors.

1. United States Published Patent Application No. 2002/0128908 to Brian E. Levin et al. on Sep. 12, 2002 for “System for Conducting User-Specific Promotional Campaigns Using Multiple Communications Device Platforms” (hereafter the “Levin Published patent application”);

2. U.S. Pat. No. 6,771,290 issued to Martin David Hoyle on Aug. 3, 2004 for “Computer Interface Method and Apparatus with Portable Network Organization System and Targeted Advertising” (hereafter the “Hoyle patent”);

3. United States Published Patent Application No. 2007/0244752 to Anthony Jeremiah Bayne on Oct. 18, 2007 for “System and Method for the Integrated Distribution of Advertising Via the Internet and Mobile Terminals” (hereafter the “Bayne Published patent application”);

4. United States Published Patent Application No. 2008/0154725 to Gary W. Flake et al. on Jun. 26, 2008 for “Engagement-Based Rewards” (hereafter the “Flake Published patent application”);

5. United States Published Patent Application No. 2009/0012861 to Dilip Krishnaswamy et al. on Jan. 8, 2009 for “Method and System for Providing Targeted Information Using Profile Attributes with Variable Confidence Levels in a Mobile Environment” (hereafter the “Krishnaswamy Published patent application”);

6. U.S. Pat. No. 7,831,462 issued to James C. Colson et al. on Nov. 9, 2010 for “Method and Apparatus for Distributing Targeted Audible Advertisements in Ringtones” (hereafter the “Colson patent”);

7. United States Published Patent Application No. 2012/0215639 to Jorey Ramer et al. on Aug. 23, 2012 for “System for Targeting Advertising to Mobile Communication Facilities Using Third Party Data” (hereafter the “Ramer Published patent application”);

8. United States Published Patent Application No. 2013/0019296 to John C. Brandenburg on Jan. 17, 2013 for “Methods and Systems for Processing Ad Server Transactions for Internet Advertising” (hereafter the “Bradenburg Published patent application”);

9. U.S. Pat. No. 8,473,350 issued to Christopher Bouret et al. on Jun. 25, 2013 for “Apparatus, Methods and Systems for Ad-Hoc Applications Based on Advertisement” (hereafter the “Bouret patent”).

The Levin Published patent application deals with a subject of a system for conducting user-specific promotional campaigns using multiple communications device platforms.

Specifically, the patent application discloses:
“A system for conducting promotional campaigns for multiple types of electronic communications devices. The promotional campaigns may include advertising and marketing campaigns involving the use of one or more of surveys, interactive games, contests, sweepstakes, location-based promotions, and tie-ins with brick-and-mortar outlets. The invention provides a process for (1) creating a promotional campaign, (2) simultaneously publishing the promotional campaign to users via a plurality of types of electronic communications devices, and (3) making the results of the promotional campaign available to the creator of the promotional campaign via communications devices of the creator's choice. Users of the system select the types of advertising and marketing campaigns in which they would be interested in participating. User-provided demographic, location, user preferences, device permissions settings and other user profile information enables creators of promotional campaigns to precisely direct those campaigns to receptive audiences and precisely monitor the success of those campaigns.”
“According to the invention, the promotional information is targeted to selected users based on information associated with the users' unique demographic profiles, instantaneous geographic locations, personal interests, buying habits, permissions settings and other parameters of interest to advertisers and marketers.”

Paragraph 28 reads as follows:
“The present invention offers a powerful new direct marketing and customer acquisition model, especially for the mobile computing paradigm. This model involves using promotions such as games and surveys to build and leverage a profiled user base. Desirably, the platform is extensible so as to allow different branded private label promotions to be executed simultaneously on different devices and for different partners. As used herein, the term “partners” includes those persons or entities who share in the revenue or other proceeds generated by operation of the promotional campaign conducting system of the present invention. Partners may or may not provide content such as games, surveys or other promotional campaigns that may be offered by the PMP. At minimum, revenue may be derived from targeting messages and advertisements to the profiled users. The network preferably has a point scoring system to provide value to reward end users. The device platforms supported may include WAP phones, personal digital assistants running the PalmOS and PocketPC devices, Voice recognition applications using VoiceXML (TellMe, for example), HTML for the Web, J2ME (Java 2 Micro Edition) mobile phones and appliances, BREW (Qualcomm proprietary language Binary Runtime Environment for Wireless) and future environments.”

The Hoyle patent discloses a computer interface method and apparatus with portable network organization system and targeted advertising. The patent discloses:

“A method and apparatus for providing an automatically upgradeable software application includes targeted advertising based upon demographics and user interaction with the computer. The software application includes a display region used for banner advertising that is downloaded over a network such as the Internet. The software application is accessible from a server via the network and demographic information on the user is acquired by the server and used for determining what advertising will be sent to the user. The software application further targets the advertisements in response to normal user interaction with the computer. Data associated with each advertisement is used by the software application in determining when a particular advertisement is to be displayed. This includes the specification of certain programs that the user may have so that, when the user runs the program (e.g., a spreadsheet program), a relevant advertisement will be displayed (e.g., an advertisement for a stock brokerage). This provides two-tiered, real-time targeting of advertising—both demographically and reactively. The software application includes programming that accesses the server to determine if one or more components of the application need upgrading. If so, the components can be downloaded and installed without further action by the user. A distribution tool is provided for software distribution and upgrading over the network. Also provided is a user profile that is accessible to any computer on the network. Furthermore, multiple users of the same computer can possess Internet web resources and files that are personalized, maintained and organized.”

The Bayne Published patent application discloses:
“A system and method for providing a mobile terminal user a rebate for the charge of a call when the user views an advertisement after the completion of the call. The user may have to view the advertisement within a specified time following the call established by the system administrator and respond to a question about the advertisement in order to earn a full or greater rebate. Viewing the advertisement may be done on the user's mobile terminal's LCD, or via an Internet enabled PC. Users who choose the latter, may access the advertisement by clicking on a hyperlink sent to them via email, or by accessing the service provider's website using a unique user PIN to login. Service providers select advertisements based on factors including location, day, time, and the user's demographic and personal interests. In a prepaid system, prepaid users may have their accounts conditionally debited pending the viewing of an advertisement.”

The Flake Published patent application discloses:
“The claimed subject matter relates to an architecture that can provide engagement-based incentives designed or intended to enrich or extend a shopping session of a shopper. In particular, the architecture can select an incentive and an engagement, each from a respective set potentially received in whole or in part from one or more vendors. The architecture can select the incentive and/or engagement based upon a location of the shopper, a profile of the shopper, or based upon other transactions occurring during a shopping session.”

The Krishnaswamy Published patent application discloses:
“Various systems and methods for of generating a user profile for use in providing targeted-content-messages to a wireless access terminal (W-AT) are disclosed. For example, a user profile with at least one profile element may be provided to the W-AT, and a profile confidence level for the profile element may be also provided.”

The Colson patent discloses:
“The illustrative embodiments described herein provide a method, apparatus, and computer program product for distributing targeted audible advertisements as ringtones. A user profile associated with a user is identified. An audible advertisement is selected from a plurality of audible advertisements using criteria matching the user profile. A currently selected ring tone is substituted with the audible advertisement on a communication device associated with the user.”

The Brandenburg Published patent application Specifically, the patent application discloses:
“Computer systems and methods for processing ad server transactions are provided. In some embodiments, the computer systems and methods may comprise determining an application to execute on an Internet-connectable device in response to a user interaction with an advertisement displayed on the Internet-connectable device; causing the Internet-connectable device to execute the application; receiving a security token, wherein the security token indicates successful authentication of the user by a transaction server associated with the application; after receiving the security token, initiating at least one transaction with the transaction server on behalf of the application in response to a user action within the application; and communicating results of the at least one transaction to the user.”

The Bouret patent discloses:
“The disclosure details the implementation of apparatuses, methods and systems for a Framework for Ad-hoc Applications Based on Advertising (FAABA). The FAABA may employ short-range radio-frequency communications. The disclosure teaches mechanisms for providing targeted advertising in connection with ad-hoc applications/point-to-point (P2P) communications between user terminals. In a manner, the invention teaches general collection components for user terminals, which is responsible for collecting and maintaining a dynamic set of advertisements as a background operation. This allows the user terminals to initiate applications that are based on P2P communication, and furthermore, allows collections of pre-loaded advertisements to be provided to the user terminals along and/or during the P2P communications. Also, the FAABA teaches that after advertisements are stored in the receiving device, the advertisements can be tailored more closely to the interests of the user of the device and the advertisements can be filtered based on current context of the user.”

The Ramer Published patent application discloses a system for targeting advertising to mobile communication facilities using third party data. The abstract of the patent application discloses:
“A system for targeting advertising content includes the steps of: (a) receiving first and second requests for advertising associated with first and second users, wherein the users are identified; (b) retrieving data pertaining to the users from a data provider; (c) selecting respective advertising content from the first and second sponsors based at least on a determination of relevancy of each advertising content to the data provider's data, wherein the relevancy determination generates respective relevancy scores; (d) determining the advertising content of the first sponsor is more relevant to the first user and the advertising content of the second sponsor is more relevant to the second user based on the respective relevancy scores; and (e) transmitting the advertising content of the first sponsor to the first mobile communication facility for display and transmitting the advertising content of the second sponsor to the second mobile communication facility for display.”

### SUMMARY OF THE INVENTION

The present invention is a new and novel software application which utilizes a portable electronic device, which portable electronic device is selected from the group that is presently available which includes a cell phone, a smart phone, and any other portable electronic device presently existing where a user needs to input a text message by manipulating keys on the device and at the same time, must be looking at a screen which provides a visual image that the user can see. One example of such a device is a smart phone and one method for providing the messaging is text messaging. The nature of the text messaging can be SMS text messaging where the message is transmitted wirelessly through SMS text messaging or text messaging which uses a wireless carrier dealer plan of the system that the individual is using for communicating messages.

An example of the present invention also includes requires that the portable electronic device in addition to transmitting a message with words through inputting key strokes on the device also has a portion which takes a visual image which is in a captured area such as a bubble where a text message appears and a visual image can also concurrently appear after the end of the text message after a predetermined number of text messages have been transmitted. In addition, the present invention involves delivering the text message or equivalent message to at least one receiver of the text message, with a targeted advertisement embedded within the text message visual framework upon the sending of a predetermined number of tet messages, which in the present invention is a captured bubble which contains the written words of the text message and a visual image of an advertisement immediately after the send message on the text message has been sent after a predetermined number of text messages have been sent by the user. The advertisement can be embedded in a registered user's portable electronic device and only becomes visible immediately upon the registered user sending of the last of the predetermined number of text messages and becomes invisible after the next text message is sent until the last of the next sequence of predetermined number of text messages is sent and only becomes visible upon the sending of the last text message in the sequence. Alternatively, the advertisement is only embedded in a registered user's portable electronic device and only becomes visible immediately upon the registered user sending of the last of the predetermined number of text messages and becomes invisible after the next text message is sent until the last of the next sequence of predetermined number of text messages is sent and is only then visible upon the sending of the last text message in the sequence.

Another element of the present invention is that the advertisement is a targeted advertisement embedded within the screen and directed toward a target audience that has been determined would be receptive to purchase the product or service displayed on the advertisement.

The advertisement appears on the user's text message and also on the recipient's text message after a predetermined number of text messages has been sent by the user, with the embedded advertising repeatedly appearing on the user's portable electronic device when the predetermined number of text messages has been sent by the user after a select set of a number of text messages, and continuing for multiple sets of text messages. At the time the visual image of an advertisement appears after the predetermined number of text messages have been sent by the user, that same image then also appears on the portable electronic device of the recipient on the sequenced number of text messages sent by the user.

For purposes of the present invention, messaging is selected from the group consisting of words, a visual image or a moving video image. In addition, the recipient after the selected number of text messages have been sent, will also receive the same text message in the same format of words, a picture or a video. In addition, the advertisements can take place in either the form of words or a still picture or a streaming video and this advertisement will appear after a selected number of text messages have been sent and therefore, the variations of the present invention include text messaging in any format such as words, picture or streaming videos and the advertisement is embedded in the captured area such as a bubble which advertisement is immediately beneath the text message, with text message and advertisement within in bubble. The advertisement can either be in words or pictures or streaming video. Also, it is within the spirit and scope of the present invention for the text message to combine any two or three of the elements so that words can be combined with still images or streaming video or the still images can be combined with streaming video and the streaming video can be combined with words and streaming video. Also, the advertisement again can appear the same way, being either with words or words combined with a still image or words combined with a streaming video or a still image combined with a streaming video.

After the user has downloaded the software application to the portable electronic device, the user is required to register the software application with the software application host who is controlling the software application. The registration process requires at a minimum inputting of basic information about the user including name, communication information such as email address, cellular telephone and the user's postal zip code. In addition, the currently existing portable electronic devices are constantly undergoing technological improvements and changes and being updated to being of better quality or better systems. Therefore, the present invention utilizes incorporating the present invention into any future developed portable electronic device which is an embellishment or enhancement or even a modification of the presently known portable electronic devices. The software application is most commonly downloaded into the user's mobile electronic device or can be installed at the time the mobile electronic device is purchased.

The present invention software application can be used with any presently known portable electronic device. For purposes of the present invention, a portable electronic device is selected from the group consisting of a cell phone, a smartphone and any other device into which a text message is inputted (which text message is as defined above), transmitted to and received by another portable electronic device. The portable electronic device into which a text message is inputted and transmitted can be the same as the portable electronic device which receives the text message. Alternatively, the portable electronic device into which a text message can be inputted and transmitted can be different from the portable electronic device which receives the text message. The user must be registered with the present invention host. However, the receiver does not have to be registered with the present invention host and can either be registered or not registered and can still receive the text message and the advertisement within the boundary set such as a bubble. The only requirement is that the portable electronic device of the sender must be individually registered with the present invention software application host. The receiver does not have to be registered. However, alternatively, the receiver may be registered. Registering on the part of the receiver is not a requirement, but just an option.

The present invention software application also envisions use with other mobile electronic devices which may be created in the future. The minimum requirements for a mobile electronic device to use the present invention software application are as follows:
(a) the user of a text message received and transmitted by a mobile electronic device can be registered with the present invention software application host, however it is not necessary for a receiver to be registered with the software application of the present invention host in order to be able to receive text message;
(b) the receiver of a text message to a portable electronic device may be registered with the present invention software application or optionally, does not have to be registered with the present invention software application to receive the text message and the advertisement;
(c) the mobile electronic device of a user of the mobile electronic device enables the user to input at least one text message into which an advertisement has automatically been embedded into the user's text message through the present invention software application host and enables the user to transmit such text message to a receiving mobile electronic device which can be registered with the present invention software application host, and respond to the user with a text message or retransmit the text message to the third party mobile electronic device which also has the present invention software application registered with the host of the present invention software application; however, in order to do this, the recipient must also be registered with the present invention software application; the embedded advertisement continuously remains in the text message but only becomes visible after a selected number of text messages have been sent by the user and the user hits the send button after the last of the text messages in the required sequenced number of text messages sent and then the image will automatically appear. Alternatively, the advertisement is only embedded with the last text message in the sequence and becomes embedded and visible only after the last in the predetermined sequence of text messages is sent. Because the advertisement is already inside the same bubble, the advertisement does not cause or create an additional text message to be generated. It is simply automatically always in the text message but only becomes visible to both the user and the recipient after the user has sent a predetermined selected number of text messages which automatically then causes the advertisement to become visible (or is automatically embedded and visible after the user has sent the predetermined number of text messages); and
(d) the fundamental innovation is that all communication is performed through text messaging as defined above.

In another embodiment, the present invention is a Android mobile messaging application that uses the built-in functionality in Android OS in order to receive and send text messages. Upon registration, the users list their interests, which can then be used by advertisers to target specific populations. The software application lets the user earn money, or any other form of compensation for the messages the user sends by including targeted advertising, which text message has embedded within in it the targeted advertisement in the the Nth message sent by a user in a text message communication. Advertisers are able to target a specific population of users, upload their ad with a link, set their budget and schedule their campaign. Users earn points or cents for at least one advertisement sent through their device and then redeem the points earned for a variety of electronic gift cards, direct cash withdrawals, charity donations, or towards their school tuition. Advertisements sent may come from the actual user's device and may come from the host server. It is also within the spirit and scope of the present invention for no points or cents to be earned when an advertisement is sent through their device.

The purpose of the present invention is to provide a downloadable application for which a multiplicity of different advertisers will pay to have their advertisements appear on a registered user's portable electronic device after the registered user sends a certain number of text messages. The advertisement will appear after the user hits the send button after a preselected number of text messages is sent. The text message and advertisement will appear in a software application bubble.

In summary, the present invention mobile software application works as follows:

1. An advertiser creates a profile on the present invention website.

2. The advertiser provides appropriate compensation for running the advertisement over a given period of time to select an advertising audience which it is determined will be most receptive to the specific product or service provided by the advertiser.

3. The advertisement is uploaded to the present invention website or through any other portal of the software application host.

4. The advertiser in conjunction with the host running the present invention website will determine the specific demographic of the advertisements to be marketed so that specific advertisements for products and services that are particularly attractive to individuals of a certain gender, ethnicity, age or location based on the individual's GPS will be determined and the advertisements will be focused to that group so that the advertisement is most effective.

With respect to the specific users being able to avail themselves of the benefits of the present invention, the present invention will provide the following course of action to an owner of a mobile device which, by way of example, can be a cell phone such as a smartphone which operates on any of the current iPhone® systems which include iPhone® 4 and more advanced products, iPad® devices and iPod Touch® and Android® based running systems, and any other future technological updates to these systems which operate mobile electronic devices such as a cell phone, iPhone®, iPad® etc.

The steps that the user will take which are part of the present invention are as follows:

1. A user downloads the present invention mobile software application and creates an account for the user.

2. Advertisements which are paid for by one of the multiplicity of advertisers as described above will be assigned to the user based on demographic information. The demographic information is selected from the group consisting of age of the individual, gender of the individual, ethnicity of the individual, the geographic location where the individual resides and/or works or their current location using GPS, the places where the individual may be going to school if they are of school age, the type of business that the individual is working in if the individual is beyond school age, the income of the individual if known, the individual's preferences in terms of types of products or services that particular individual has purchased and will continue to purchase in the future. These are representative examples of the demographics which are incorporated for use with the present invention. After initial registration, the host will prompt the user to provide more personal information so that advertisements can be directed to the products and services of greatest interest to the user. Eventually, the user can select a specific brand to promote and be a brand ambassador.

4. The users will continue to use their mobile electronic device such as a cell phone with no adjustment to behavior of the individual user.

5. Periodically, and set by strong security controls and preferences, an advertisement is generated in response to text messages and phone calls received by the user. By way of example, the following would apply:
5.1 After the user has received and responded to five text messages from a particular number, an advertisement which is one of the purchased advertisements from the multiplicity of advertisers as discussed above is embedded within the text message of the sender and becomes visible after a selected number of text messages has been sent by the sender. No further advertisements are sent to that number for a defined time period.

6. At the end of the day, a daily activity report is generated by the software application and sent to the web master—host. The report is checked for errors and security issues. The report contains a minimum of the following:
6.1 The volume of text messages sent and received;
6.2 The number of advertisements generated by that user.

7. Based on the number of advertisements generated by the user, the user's account is credited with points redeemable for compensation.

8. After points have been accumulated, the user can then convert them into gift cards, discounts and promotions offered by the software application host. The compensation can also include money or any other compensation of value as determined by the software application host.

9. Not only does the user benefit, but the provider's advertisers create a new marketing channel that connects them to individual social networks. This gives them micro-access to their customer base and allows them to use the present invention mobile software application as champions of the advertisers' brand and message. It is a new marketing niche that is created by the present invention.

10. With respect to the advertisers, at the end of each day or other assigned period of time, the advertiser receives a report outlining:
10.1 How many specific users sent their advertisements;
10.2 How many total advertisements were sent;
10.3 How many users redeemed their points for an offer from the advertiser; and
10.4 A click through rates, CPMs, and any other advertising means.

While a bubble has been described as the framework in which the advertisement will appear, the framework shape can be any shape such as a bubble, any geometric shape, any polygonal shape within which the text message and advertisement appear or no framework and the text message and advertisement appear together with the advertisement preferably below the text message.

One description of the present invention is a software application, comprising: (a) a registration method by which a user downloads the software application into a portable electronic device of the user that enables the user to register the downloaded software application with a host of the software application so that the user becomes a registered user; and (b) the software application requires text messaging by the registered user to create and send a text message to at least one receiver of the text message, with a targeted advertisement is embedded within each text message of the registered user but is not visible so that the targeted advertisement appears on a screen of the portable electronic device of the registered user after a predetermined number of text messages have been sent by the registered user to any receiver of each text message, with the embedded advertising repeatedly appearing and visible on the user's portable electronic device after each series of a predetermined number of text messages have been sent by the user to any receiver of each text message, the user compiling reward compensation amounts after each amount of predetermined number of text messages have been sent by the registered user to any receiver of any text message.

The present invention also includes the software application as defined in paragraph [0072] above, further comprising: (a) the registered user is required to register the software application with the software application host who is controlling the software application; and (b) registration requires at a minimum inputting of basic information about the registered user including the registered user's name, email address and post office address.

The present invention also includes the software application as defined in paragraph [0072] above, further comprising: (a) the portable electronic device of the registered user is selected from the group consisting of a cell phone, a smartphone, a personal digital assistant (PDA), a palmtop, and a portable PC; and (b) the text message is received by a portable electronic device of the registered user is selected from the group consisting of a cell phone, a smartphone, a personal digital assistant (PDA), a palmtop and a portable PC.

The present invention also includes the software application as defined in paragraph [0072] above, further comprising: (a) the receiver of a text message from a registered user is required to download the software application on the receiver's portable electronic device and is required to register the software application with the software application host who is controlling the software application; and (b) registration requires at a minimum inputting of basic information about the receiver including the receiver's name, email address and post office address.

The present invention also includes the software application as defined in paragraph [0072] above, further comprising: (a) the receiver of the text message from a registered user is not required to download the software application on the receiver's portable electronic device and therefore, a non-registered receiver can simply receive a text message but not send a text message to any third party or back to the receiver under the present software application.

The present invention also includes the software application as defined in paragraph [0072] above, further comprising: (a) the registered user through the mobile electronic device enables the registered user to input at least one text message into which an advertisement is embedded from the software application host and enables the registered user to transmit such text message to a receiving mobile electronic device of a receiver who is also registered with the software application host to become a registered receiver, and the registered receiver through a receiving mobile electronic device responds to the registered user with a text message and is able to retransmit the text message to a third party mobile electronic device; and (b) all communication is performed through text messaging.

The present invention also includes the software application as defined in paragraph [0072] above, further comprising: (a) the compensation to the registered user is redeemable points which can be redeemed for rewards selected from the group consisting of electronic gift cards, direct cash withdrawals, charity donations, and school tuition.

A software application, comprising: (a) a downloadable software application for which a multiplicity of different advertisers will pay to have their advertisements appear on a registered user's portable electronic device after a registered user sends a certain number of text messages; (b) the advertisement appears and is visible after the registered user hits a send button after a preselected number of text messages is sent; and (c) the test message and advertisement will appear in a software application framework so that the text message appears in the framework and the advertisement appears immediately below the text message in the bubble.

The present invention also includes the software application as defined in paragraph [0079] above The software application in accordance with Claim 8, further comprising: the advertisement is embedded in the software application downloaded into the portable electronic device but is only visible after a predetermined number of text messages is sent by the user and only is visible when a last text message in a sequenced of predetermined number of text messages is sent.

The present invention also includes the software application as defined in paragraph [0079] above, further comprising: the advertisement is embedded in the software application downloaded into the portable electronic device after a predetermined number of text messages is sent by the user and only is visible when a last text message in a sequence of predetermined number of text messages is sent.

A software application, comprising: (a) a downloadable software application for which a multiplicity of different advertisers will pay to have their advertisements appear on a registered user's mobile electronic device after a registered user sends a certain number of text messages; (b) the advertisement appears after the registered user hits a send button after a preselected number of text messages is sent; and (c) the test message and advertisement will appear in a software application framework outline so that the text message appears in the framework outline and the advertisement appears immediately below the text message in the framework outline.

The present invention also includes the software application as defined in paragraph [0082] above, further comprising: the framework is selected from the group consisting of a bubble, a two dimensional geometric shape and a polygonal shape.

The present invention is also defined as a software application, comprising: (a) a downloadable software application for which a multiplicity of different advertisers will pay to have their advertisements appear on a registered user's mobile electronic device after a registered user sends a certain number of text messages; (b) the advertisement appears after the registered user hits a send button after a preselected number of text messages is sent; and (c) the test message and advertisement will both appear on a visible screen of the mobile electronic device and are separated so that the advertisement is either below or above the text message.

The present invention is additionally defined as a downloadable mobile software application comprising: (a) the downloadable mobile software application is downloadable to a portable electronic device and a user is required to register with a host of the software application and the user must create and send text messages using the portable electronic device; (b) an advertisement is placed into the downloadable mobile software application, which advertisement is embedded in the downloadable mobile software application and contains advertisements for products and services that are generated based upon specific user profiles selected from the group consisting of user age, user gender, user location, user job, user income, user hobbies, user preferences for purchases of products or services; (c) the downloadable mobile software application transforms the advertisement to be visible with a text message only at selected times after a last text message in a sequenced given number of text messages is sent in the portable electronic device into which the mobile software application is loaded; (d) the downloadable mobile software application transforms the way an advertisement is directed to a specific focus group of consumers who are the registered user who will have to be looking at the advertisement because the consumers will be required to look at a screen while the consumer is text messaging; (e) the consumer is awarded incentives to use the mobile software application to deliver a multiplicity of text messages to different contacts of the user and will receive compensation in the form of redeemable gift documents based upon the quantity of text messages generated by the user which contain the embedded advertisement; (f) a tracking system to track how frequently the user uses the downloadable software to determine compensation to be provided by the advertiser and a tracking method to provide to advertisers to determine how often the user has used the advertisement through text messaging to determine whether a group of consumers targeted by the advertiser has increased sales of advertiser's products or services to the targeted group of consumers; and (g) the selected text message and the advertisement appear together in a framework after the selected number of text messages have been sent so that the text message and the advertisement both appear in the same framework outline.

The present invention also includes the software application as defined in paragraph [0085], further comprising: (a) the framework is selected from the group consisting of a bubble, a rectangle, and a polygonal outline.

The present invention additionally includes a downloadable software application, comprising: (a) the downloadable software application is downloadable to a portable electronic device of a user who must register the software application with a host to become a registered user; (b) the registered user creates and sends text messages with the portable electronic device; (c) an advertisement is placed into the software application, which advertisement is embedded in the software application either at any time or only after a predetermined number of text messages are sent, the advertisement is visible with a text message only after a predetermine number of text messages are sent and contains advertisements for products that are generated based upon specific user profiles for registered users who may purchase the products or services of the advertiser; and (d) the software application is programmed so that after the registered user sends a selected number of text message, the advertisement will appear on a screen of the portable electronic device immediately after a send button is pressed to transmit the last of a required number of text messages have been sent by the registered user through the portable electronic device.

The present invention also includes a downloadable software application as defined in paragraph [0087] above, further comprising: the registered user is awarded incentives to use the software application to deliver a multiplicity of text messages to a respective different contact of one or more receivers of the text messages and the user will receive compensation in the form of redeemable gift documents based upon the quantity of text messages generated by the user which contain the embedded advertisement.

The present invention also includes the downloadable software application as defined in paragraph [0087], further comprising: a tracking system to track how frequently the user uses the downloadable software application to determine compensation to be provided to the advertiser and a tracking method to provide to advertisers to determine how often the user has used the advertisement through text messaging the software application and to determine whether the group of consumers targeted by the advertiser has had an effect on consumer's purchasing products or services sold by the advertiser which were advertised in the text messages of the registered user.

The present invention also includes a computer implemented method of modifying a short messaging service message, comprising: (a) receiving at a mobile device of a first user, via an application installed on the mobile device of the first user, content provided by a content provider; (b) detecting that the first user has instructed the mobile device to transmit a first short messaging service message to a device of a second user, the first short messaging service message including a message entered by the first user, (i) wherein the message entered by the first user does not include the content from the content provider; (c) determining if the mobile device of the first user has transmitted a first threshold number of short messaging service messages to the device of the second user; (d) at least partly in response to determining that the mobile device has transmitted the first threshold number of short messaging service messages to the device of the second user; (i) causing, at least in part, the first short messaging service message to automatically include the content from the content provider with the message entered by the first user; and (ii) causing at least in part, the content from the content provider to be displayed in association with the message entered by the first user when displayed on the device of the second user.

The present invention further includes the method as identified in paragraph [0090] above, the method further comprising determining demographic information of the first user, wherein the content is selected for inclusion in the first short messaging service message at least partly in response to the demographic information.

The present invention also includes the method as identified in paragraph [0090] above, wherein the content is included in each of the first threshold number of short messaging service messages but is not displayed by the device of the second user in association with respective messages entered by the first user.

The present invention also includes the method as identified in paragraph [0090] above, the method further comprising inhibiting the display of the content in at least one short messaging service message transmitted from the mobile device of the first user to the device of the second user after the transmission of the first short service message.

The present invention also includes the method as identified in paragraph [0090] above, wherein the content is not included in any of the first threshold number of short messaging service messages.

The present invention also includes the method as identified in paragraph [0090] above, wherein the first short messaging service message is an SMS message.

The present invention also includes the method as identified in paragraph [0096] above, wherein the short messaging service is operated by a provider of the application

The present invention also includes the method as identified in paragraph [0096] above, wherein the first short messaging service message is an MMS message.

The present invention also includes the method as identified in paragraph [0096] above, the method further comprising: (a) tracking a number of items of content provided by one or more content providers that are transmitted via short messaging service messages from the mobile device of the first user; and (b) generating a report indicating the number of items of content provided by one or more content providers that are transmitted via short messaging service messages from the mobile device of the first user.

The present invention also includes the method as identified in paragraph [0096] above, the method further comprising: (a) tracking a number of items of content provided by one or more content providers that are transmitted via short messaging service messages from the mobile device of the first user within a first period of time; (b) determining whether the number of items of content provided by one or more content providers that are transmitted via short messaging service messages from the mobile device of the first user within the first period of time at least meets a second threshold; and (c) at least partly in response to determining that the number of items of content provided by one or more content providers that are transmitted via short messaging service messages from the mobile device of the first user within the first period of time at least meets a second threshold, inhibiting content from one or more content providers from being included in short messaging service messages from the mobile device of the first user for a second period of time.

The present invention also includes the method as identified in paragraph [0096] above, the method further comprising, causing the content from the content provider to be displayed on the device of the second user adjacent to, and below the message entered by the first user.

The present invention also includes the method as identified in paragraph [0096] above, wherein the content from the content provider includes at least a video file.

The present invention also includes the method as identified in paragraph [0096] above, the method further comprising, causing, at least in part, a graphic separator to be displayed visually separating the content from the content provider from the message entered by the first user when displayed on the device of the second user.

The present invention also includes the method as identified in paragraph [0096] above, the method further comprising, causing, at least in part, the content from the content provider and the message entered by the first user to be displayed within the same short message graphic frame when displayed on the device of the second user.

The present invention also includes the method as identified in paragraph [0096 above, wherein the message entered by the first user comprises text entered by the user.

The present invention is also defined as a computer implemented method, comprising: (a) providing an application for installation on a device of a first user; (b) detecting that the first user has instructed the application, installed on the device of the first user, to transmit a first mobile messaging service message to a device of a second user, the first mobile messaging service message including a message entered by the first user; (c) causing, at least in part, the first mobile messaging service message to automatically include the content from the content provider with the message entered by the first user; (i) wherein the message entered by the first user does not include the content from the content provider; and (ii) wherein the content from the content provider is displayed in a messaging visual frame in association with the message entered by the first user when displayed on the device of the second user.

The present invention also includes the method as identified in paragraph [0105] above, the method further comprising determining demographic information of the first user, wherein the content is selected for inclusion in the first mobile messaging service message at least partly in response to the demographic information.

The present invention also includes the method as identified in paragraph [0105] above, wherein the first mobile messaging service message is an SMS message or an MMS message.

The present invention also includes the method as identified in paragraph [0105] above, wherein the mobile messaging service is operated by a provider of the application.

The present invention also includes the method as identified in paragraph [0105] above, the method further comprising: (a) tracking a number of items of content provided by one or more content providers that are transmitted via mobile messaging service messages from the device of the first user; and (b) generating a report indicating the number of items of content provided by one or more content providers that are transmitted via mobile messaging service messages from the device of the first user.

The present invention also includes the method as identified in paragraph [0105] above, the method as defined in Claim 34, the method further comprising: (a) tracking a number of items of content provided by one or more content providers that are transmitted via mobile messaging service messages from the device of the first user within a first period of time; (b) determining whether the number of items of content provided by one or more content providers that are transmitted via mobile messaging service messages from the device of the first user within the first period of time at least meets a first threshold; and (c) at least partly in response to determining that the number of items of content provided by one or more content providers that are transmitted via mobile messaging service messages from the device of the first user within the first period of time at least meets a first threshold, inhibiting content from one or more content providers from being included in mobile messaging service messages from the device of the first user for a second period of time.

The present invention also includes the method as identified in paragraph [0105] above, the method further comprising, causing the content from the content provider to be displayed on the device of the second user adjacent to, and below the message entered by the first user.

The present invention also includes the method as identified in paragraph [0105] above, the method further comprising, causing, at least in part, a graphic separator to be displayed visually separating the content from the content provider from the message entered by the first user when displayed on the device of the second user.

The present invention also includes the method as identified in paragraph [0105] above, wherein the short messaging visual frame is a bubble frame or a rectangular frame.

The present invention is also defined as a communication system, comprising: (a) at least one computing device; (b) a non-transitory computer-readable medium having computer-executable instructions stored thereon that, if executed by the at least one computing device, cause the at least one computing device to perform operations comprising: (i) detecting that a first user has instructed an application, downloaded to a device associated with the first user, to transmit a first mobile messaging service message to a device of a second user, the first mobile messaging service message including a message entered by the first user; (ii) automatically causing, at least in part, content from a content provider to be displayed in association with the message entered by the first user when the content from the content provider and the message entered by the first user are displayed on the device of the second user, (iii) wherein the message entered by the first user does not include the content from the content provider; and (c) wherein the content from the content provider is displayed adjacent to, but visually separated from the message entered by the first user.

The present invention also includes the method as identified in paragraph [0104] above, the operations further comprising determining demographic information of the first user, wherein the content is selected for inclusion in the first mobile messaging service message at least partly in response to the demographic information.

The present invention also includes the method as identified in paragraph [0104] above, wherein the first mobile messaging service message is an SMS message or an MMS message.

The present invention also includes the method as identified in paragraph [0104] above, the operations further comprising: (a) tracking a number of items of content provided by one or more content providers that are transmitted via mobile messaging service messages from the device of the first user; and (b) generating a report indicating the number of items of content provided by one or more content providers that are transmitted via mobile messaging service messages from the device of the first user.

The present invention also includes the method as identified in paragraph [0104] above, the operations further comprising: (a) tracking a number of items of content provided by one or more content providers that are transmitted via mobile messaging service messages from the device of the first user within a first period of time; (b) determining whether the number of items of content provided by one or more content providers that are transmitted via mobile messaging service messages from the device of the first user within the first period of time at least meets a first threshold; and (c) at least partly in response to determining that the number of items of content provided by one or more content providers that are transmitted via mobile messaging service messages from the device of the first user within the first period of time at least meets a first threshold, inhibiting content from one or more content providers from being included in mobile messaging service messages from the device of the first user for a second period of time.

The present invention also includes the method as identified in paragraph [0104] above, the operations further comprising, causing the content from the content provider to be displayed on the device of the second user adjacent to, and below the message entered by the first user.

The present invention also includes the method as identified in paragraph [0104] above, the operations further comprising, causing, at least in part, a graphic separator to be displayed visually separating the content from the content provider from the message entered by the first user when displayed on the device of the second user.

The present invention also includes the method as identified in paragraph [0104] above, wherein the content from the content provider and the message entered by the first user are displayed within a short messaging visual frame.

The present invention is also defined as a non-transitory computer-readable medium having computer-executable instructions stored thereon that when executed by a computer comprising hardware, cause the computer to perform operations comprising: (a) detecting that a first user has instructed an application, downloaded to a device associated with the first user, to transmit a first mobile messaging service message to a device of a second user, the first mobile messaging service message including a message entered by the first user; (b) automatically causing, at least in part, content from a content provider to be displayed in association with the message entered by the first user when the content from the content provider and the message entered by the first user are displayed on the device of the second user; (c) wherein the message entered by the first user does not include the content from the content provider, and (d) wherein the content from the content provider is displayed adjacent to, but visually separated from the message entered by the first user.

The present invention also includes the non-transitory computer-readable medium as defined in paragraph [0122] above, further comprising: (a) tracking a number of items of content provided by one or more content providers that are transmitted via mobile messaging service messages from the device of the first user within a first period of time; (b) determining whether the number of items of content provided by one or more content providers that are transmitted via mobile messaging service messages from the device of the first user within the first period of time at least meets a first threshold; and (c) at least partly in response to determining that the number of items of content provided by one or more content providers that are transmitted via mobile messaging service messages from the device of the first user within the first period of time at least meets a first threshold, inhibiting content from one or more content providers from being included in mobile messaging service messages from the device of the first user for a second period of time.

The present invention also includes the non-transitory computer-readable medium as defined in paragraph [0122] above, the operations further comprising: causing the content from the content provider to be displayed on the device of the second user adjacent to, and below the message entered by the first user.

The present invention also includes the non-transitory computer-readable medium as defined in paragraph [0122] above, the operations further comprising: causing, at least in part, a graphic separator to be displayed visually separating the content from the content provider from the message entered by the first user when displayed on the device of the second user.

The present invention also includes the non-transitory computer-readable medium as defined in paragraph [0122] above, wherein the content from the content provider and the message entered by the first user are displayed within a short messaging visual frame.

Further novel features and other objects of the present invention will become apparent from the following detailed description and discussion.

### BRIEF DESCRIPTION OF THE DRAWINGS

Referring particularly to the drawings for the purpose of illustration only and not limitation, there is illustrated:

FIG. 1A continuing to FIG. 1B is a workflow diagram of the present invention containing the information available at this time;

FIG. 2A continuing to FIG. 2B is a flow chart illustrating how a user's utilizes the present invention and illustrating a flow chart for a new message screen;

FIG. 3A is a flow chart of the entire sender/receiver process;

FIG. 3B is a continuation of FIG. 3A;

FIG. 4 is an illustration of a text message and advertisement in a bubble;

FIG. 5 is an illustration of a text message and advertisement within a rectangle;

FIG. 6 is an illustration of a text message and advertisement within a hexagon; and

FIG. 7 is an illustration of a text message and advertisement below the text message without a framework around them.

### DETAILED DESCRIPTION OF THE PREFERRED EMBODIMENTS

Although specific embodiments of the present invention will now be described with reference to the drawings, it should be understood that such embodiments are by way of example only and merely illustrative of but a small number of the many possible specific embodiments which can represent applications of the principles of the present invention. Various changes and modifications obvious to one skilled in the art to which the present invention pertains are deemed to be within the spirit, scope and contemplation of the present invention.

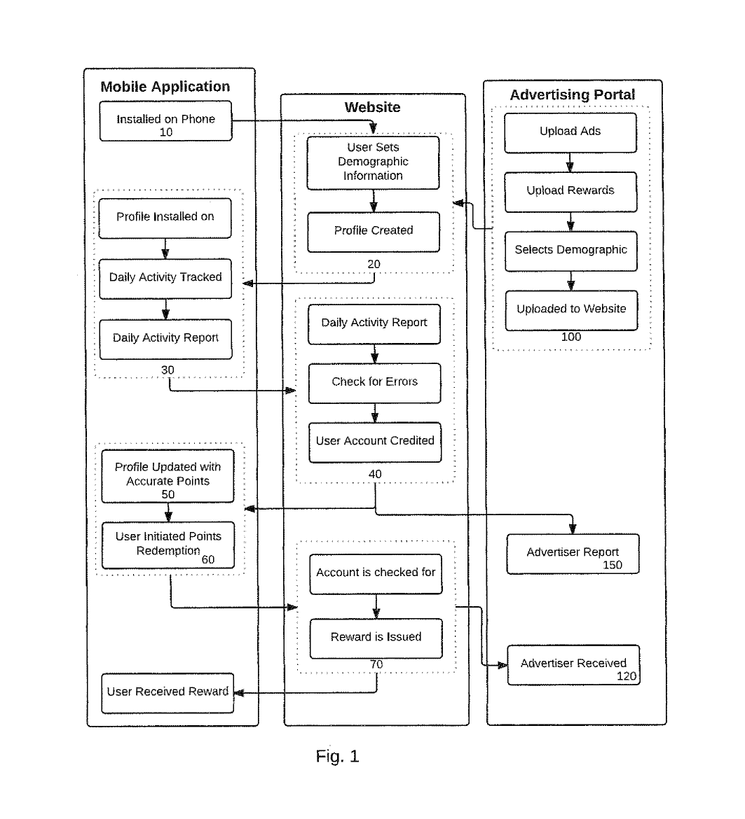

As set forth in FIG. 1, the following courses of action take place:

1. A user has the present invention mobile software application installed on the user's portable electronic device such as a cell phone listed as block 10.
1.1. The user is sent a series of questions which include questions to determine the background of the user so that the advertisements to be purchased by the paying advertisers included in the mobile software applications will be used to the maximum benefit of the advertiser. At this time the user will be asked to input through a questionnaire on the cell phone after the mobile software application has been downloaded at least the following information:
   1.1.1. As set forth in block 20, the user sets up demographic information and creates a profile;
   1.1.2 With respect to the advertisers' portal block 100, the advertiser will upload the advertisement, the advertiser will upload the rewards provided by the advertiser, the advertiser will select the demographic information in consultation with the webmaster to maximize the focus as to where the advertisements will be directed to the most receptive group who will want to acquire the advertiser's products or services and the advertisement is uploaded to the website. This is all placed into the mobile software application after the user provides the information as set forth in block 20.

2. As set forth in block 30, the profile is installed on the user's cell phone. Daily activity is tracked and a daily activity report is created.

3. As set forth in block 40, the daily activity report is received, it is checked for errors and the user account is credited.

4. As set forth in block 150, the advertiser report is created and sent to the advertiser.

5. As set forth in block 50, the user profile is updated with accurate points.

6. As set forth in block 60, the user initiates point redemption.

7. As set forth in block 70, an account is checked for errors and accuracy and then the advertiser receives a reward report 120.

8. As set forth in block 80, the user is rewarded by the receipt of gift certificates or other cards that are redeemable for merchandise from the advertiser.

An innovation of the present invention is that a user registers with the host of the present invention software application and sends text messages (as defined above) through the user's portable electronic device with an advertisement tailored to the user after a predetermined amount of text messages has been sent by the registered user. After a required number of text messages has been sent by the registered user, a framework such as a bubble will appear with the targeted advertisement appearing on the screen of the portable electronic device immediately after the registered user hits the send button. The advertisement will be in the same bubble as previously discussed. Since the registered user is looking at the screen when text messaging, the registered user will immediately see the targeted advertisement. It is not required that the receiver of the text message also be registered with the present invention software application host. However, if the receiver of the text message is also a registered user, a reply text message by the receiver converts the receiver into a text message sender and that person has a separate account to accumulate text messages sent to also accumulate a given number of text messages until an advertisement appears after the receiver/sender has sent a required number of text messages. Each registered user can accumulate any desired number of text messages to anyone. As set forth below, safeguards are provided to prevent system abuse.

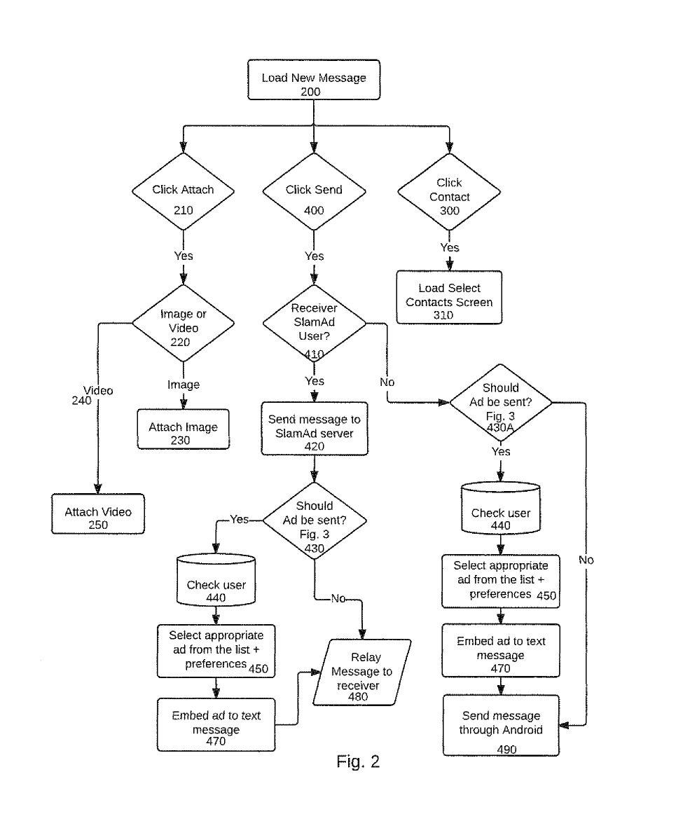

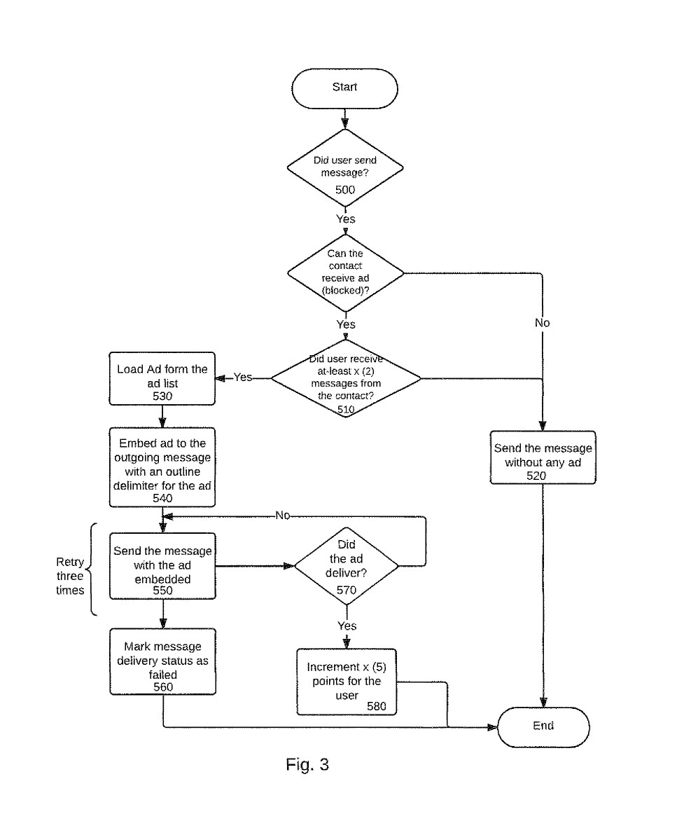

FIG. 2 illustrates a text messaging sequence by a registered user. It also illustrates a flow chart for a new message screen. The user logs in using his name and password. The registered user loads a new message screen 200 onto his portable device. If the user wishes to include an attachment to the text message, the user clicks attach 210 and selects an image or video 220. If it is an image, then the image 230 is processed. Alternatively, if the attachment is a video 240, the it is then processed 250. The user selects a contact 300 and the contact screen is loaded 310. The user then clicks send 400. The host records are checked 410 to be certain the user is a registered user and the message is sent to the server 420. The system then goes to FIG. 3 to confirm the message should be sent. 430 or 430A. In one path, the user's preference are checked 440, and an appropriate advertisement is selected from the current list and preferences of the user 450, the advertisement is embedded to a text message 470 the message is relayed to the receiver's client 480. In a parallel path, after the add is embedded to a text message 470, the message is sent through as built-in android 490.

The text message from FIG. 2 is further double checked in FIG. 3. The program asks did the user send the text message? 500. It then checks can the contact receive the message or was the ad blocked? If the answer is “No”, then the message is sent with no advertisement 520. On the other branch of the tree, if the answer is yes, then the software application chicks if the user sent at least two (2) from the contact 510 and then the advertisement is loaded from the advertisement list 530. The advertisement is embedded to the outgoing message with an outline delimiter for the advertisement 540. The message is sent with the advertisement embedded 550. If it fails, try three times. Then the system marks the message delivery as failed 560. If the message is delivered 570, five deliveries award the user points 580.

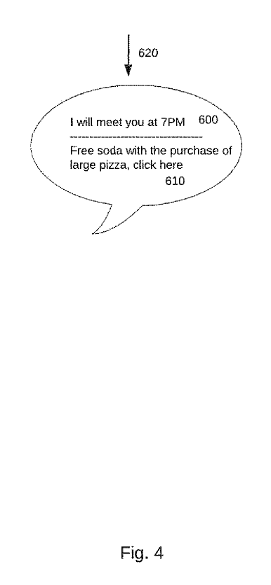

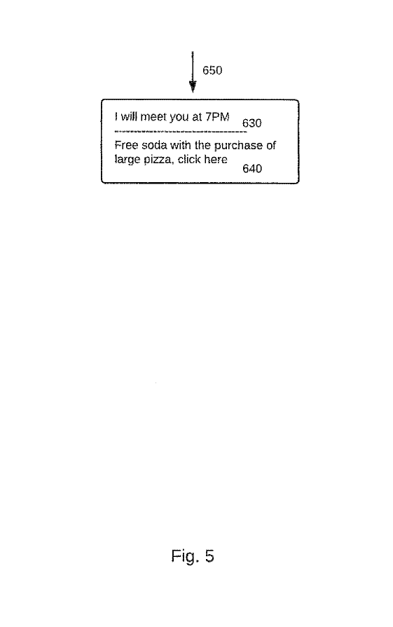

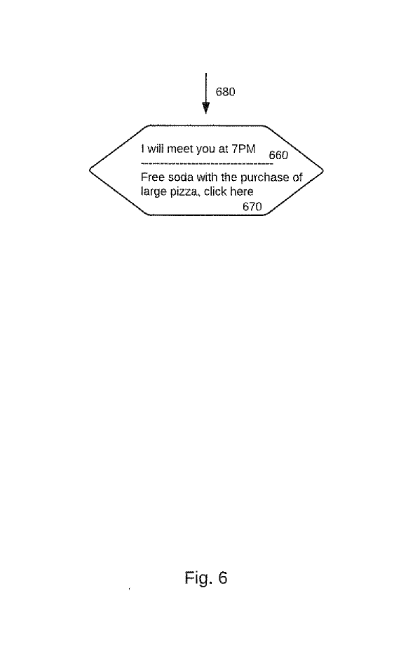

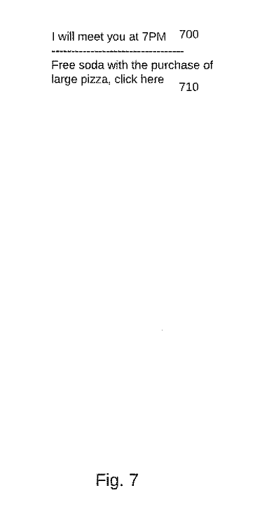

If the advertisement was delivered 570, then the text message as advertisement visible together in a framework as illustrated in FIGS. 4 through 6. FIG. 4 is an illustration of a text message 600 and advertisement 610 in a bubble 620. FIG. 5 is an illustration of a text message 630 and advertisement 640 within a rectangle 650. FIG. 6 is an illustration of a text message 660 and advertisement 670 within a hexagon 680. FIG. 7 is an illustration of a text message 700 and advertisement 710 below the text message 700 without a framework around them.

After logging on by inputting the registered user's name and password, the user signs up and receives and downloads the present invention mobile software application. When the user is asked to register the account, the user will provide the following information into the user's cell phone which will be transmitted to the webmaster controlling the present invention. These will include the mobile number of the user with the request that he/she would like to have any other information. The email address of the user is also transmitted. The user creates their own password so that only they will be able to access their account. The user will provide the information as to their gender and the country where they are residing and their zip code if the United States is selected.

The user will be provided with additional rewards and bonus points if they are willing to provide certain other sensitive information which most users are not inclined to give out initially. However, after a user has become accustomed to the system and sees that they are getting some bonus points for not modifying their behavior in any way, which bonus points can be converted to various compensation. Specifically, compensation can include users earning 5 points or 5 cents for every advertisement sent through their device and then redeem the points earned for a variety of electronic gift cards, direct cash withdrawals, charity donations, or towards their school tuition. The system will then prompt the user to provide additional information such as the user's age, the user's gender, where the user lives, if the user is in school, what they are studying in school, what grade they are in, if the user is at work, what jobs they perform, the user's income or a range of income on an annual basis, the types of products and services that the user usually purchases and products and services the user would like to purchase within the next several months, and other highly sensitive information that the user ordinarily would not provide unless given an incentive.

The mobile software application program will then automatically match the user with the specific companies and brands that advertise products or services that will be of most interest for purchase by the specific user based upon the specific user information as above. There will also be additional questions asked of the user, perhaps of a more personal nature, in order to enable them to provide more detailed information which would include the income earned by the user, the age of the user, the religion of the user; if the user is going to school, where they are going to school and what they are studying; if the user has graduated from school, where they are working; the nature of their employment; their interests, their hobbies and what products and services they have acquired within the last year.

In summary, the present invention will work as follows. The user will receive the advertisement as selected by the advertiser based on the user's demographic that will be embedded in the user's portable electronic device as a text message. Text message is defined as SMS text messaging where the message is transmitted wirelessly through SMS text messaging or text messaging which uses a wireless carrier dealer plan of the system that the individual is using for communicating messages. The advertisement will then be run based upon the text message sent from the user's portable electronic device to a portable electronic device having the present invention mobile application software downloaded to it. While it may be embedded in the fifth message, this is one example and it could be embedded in every single message or in every other message or in any other selected sub-group of text messages to be sent by the user to an individual. If the text message appears, then this is placed in the computer database so it is indicated that the user used the text message with the advertisement for a given number of times every day.

The present invention takes an advertisement and transforms it into a transmittable advertisement through the present invention mobile software application so that the advertisement can be embedded into a text message as defined in the above paragraph sent by the user who downloaded the present invention mobile software application into the user's cell phone to a receiver optionally having the present invention mobile software application with the messages to be transmitted at specific selected time periods such as every text message, every other text message etc. The key is that the advertisement is transformed through the software application into an advertisement that is embedded into and transmitted through text messages. For example, the user sends a text message to his friend. If the same user sends the same text or a comparable text to the friend, the mobile software application is programmed so that after a given number of text messages, whether it be every single one, every other one, every third one, every fourth one, every fifth one etc., at the end of the text message, a specific advertisement will appear. The advertisement will appear immediately below the selected number of text messages which will have the advertisement and will appear in a framework which can be any shape such as a bubble or any other shape. A feature of the present invention is that the framework will be a bubble so that the specific text message that triggers the advertisement will appear within the bubble and immediately beneath the text message, the advertisement will appear within the same bubble. While a bubble is a preferred shape for the present invention, any framework of any size can also be included as a replacement for the bubble. In addition, it is within the spirit and scope of the present invention to have the text messages and the advertisement immediately below that in a running series without a framework around it. By way of example, “Drink Soda” or “Eat Pizza” or “Buy Ice Cream”. In this way, the person receiving the mobile software application will see the advertisement.

Therefore, through the present invention, an advertiser will be able to place directed advertisements directly to its subset of consumers who are directly likely consumers of the specific product or service that they are selling and are advertising it directly and personally to the individual consumer as opposed to an overall multimedia advertisement such as a television show or radio show or a billboard sign. The advertisement through the present mobile software application will be transformed from a general advertisement to an embedded advertisement contained within the mobile software application and embedded so that it appears on a screen when the user of the portable electronic device such as smartphone or cell phone, sends a text message or other communication to another user. Through this transformation, the advertisement will appear on a screen in a personal electronic device such as a cell phone, iPad® etc. where the consumer will be looking directly at the screen since they are reading the text message and therefore, will definitely be viewing the advertisement. In addition, the consumer has the motivation and incentive to text message because they will be receiving reward prize points which the user can redeem for gift cards or other cash methods of being able to cash in the non-cash certificate gift cards etc. for the products advertised by the advertising company that paid for and placed the advertisement to be run on the text message screen in the method as described.

The present invention also includes the following additional improvements to even better enhance the effectiveness of the mobile software application of the present invention. Among the information requested and downloaded from the consumer to help better direct the appropriate advertisements to the consumer will be included at least one email address, a password that is personal to the consumer so only that consumer can access how many points that consumer has earned to give them further incentive to continue to use the present invention, information concerning the consumer including whether the consumer is male or female, the country where the consumer is located and the zip codes or any other direct mail information where the consumer is located.

Through the present invention apparatus and method, the present invention mobile software application will automatically match the consumer and cell phone or other portable electronic device of the user with the companies and brands that are utilizing the present invention apparatus and method in order to match as closely as possible the type of products and services that the company is selling with the consumer to whom the advertisements about those products and services are directed.

To get even more detailed information so that the match can be even more precise, the consumer/user will be provided with additional bonus points if they are willing to give out additional information such as their age, whether they are in school and what grade they are in and what they are studying; if they are working, where their jobs are, the income that they are earning, family members that they have and that they are living with, family members whom they are not living with, the nature and type of entertainment that they enjoy, whether it be cable, streaming video etc.

Further, the consumer will even be given an opportunity to choose the type of advertisements that they wish to receive if the products or services provided by the advertiser are of a particular interest to that consumer.

The consumer will also be provided with information to enable the consumer to change the demographic information provided, assign additional cell phone numbers to the consumer's account so that if they have more than one electronic device, they can benefit from the utilization of the present invention on several devices. The advertiser will also be getting information concerning how effective their advertisement is and therefore, will have the opportunity to change the nature of the advertisement to better improve the effectiveness of the consumer wanting to utilize their advertisement and obtain products. They will also have the opportunity to modify the products that are provided to the consumer based upon the points earned by the consumer.

The method by which the consumer will be able to redeem points that the consumer earns can also be modified to include other various types of cash transactions to enable the consumer to receive gift cards, credit cards or other methods by which the consumer can redeem the points for the products provided by the specific advertiser.

As the consumer becomes more comfortable with the present invention mobile software application, the consumer will be prompted to provide even more detailed information about the consumer with the incentive being that they will have the opportunity to obtain even more bonus reward points and in addition, the opportunity to have advertisements that are of the greatest interest to the consumer. The advertiser will also have the opportunity to obtain further statistical data so that specific advertisements for products or services that a consumer has demonstrated a great interest in acquiring can be run more frequently on that consumer's mobile device.

In addition, the system will have further enhancements including information concerning times of the day and days of the week when a consumer most frequently used the present invention mobile software application, how the invention mobile software application is used such as through text messaging, and whether the consumer also generated more sales leads through providing the information to the consumer's friends, relatives, etc. who also then subsequently obtained the mobile software application to receive the benefits of the present invention.

The compensation to be allocated between the webmaster provider of the mobile software application and the consumer will be adjusted periodically to determine the best results for both.

There are key transformations in the present invention which include:

1. The downloadable mobile software application of the present invention transforms an ordinary text message into a source of advertising.

2. The downloadable mobile software application transforms the way an advertisement is directed to a specific focus group of consumers who are the registered user who will have to be looking at the advertisement because the consumers will be required to look at a screen while they are text messaging or receiving a text message.

3. The receiver of the text message can be a registered user but does not have to be a registered user. If the receiver of the text message is the registered user, then the registered receiver can also send text messages and after a selected number of text messages can receive the reward as described above for the registered user. The registered receiver will also have the same limitations on the number of text messages that can be sent to the same person for rewards limited over a certain period of time so there are no more than two text messages over a twenty-four hour period. In addition, the receiver can be non-registered so that they will be able to receive the text message but cannot resend it either to the user or to a third party as a registered receiver could do.

Through the present invention, the data can be acquired and calculated and tabulated in order to perform various permutations and calculations to determine improvements to the operation of the present invention which include particular companies or industries that most benefit from these types of advertisements, the advertising message that is most effective, the number of advertisements sent and whether they are particularly sent at specific times of the day. In addition, advertisements of one kind or another may have a different effect on consumers if they are in different countries or in different locations within a particular company which will also be factored into the advertisements that are provided to that particular sub-group of persons depending upon the numerous variables about that person that are obtained and continuously updated.

In order to avoid fraud or other misuse of getting rewards through the present invention, the consumer will agree to various terms and conditions as part of the opportunity to utilize the present invention mobile software application. Examples include, but are not limited to, the sender being asked to send out only a limited number of messages over a given period of time. The user can only send a text message to another person for a specific limited number of times over a specific period of time, for example such as no more than two text messages within any twenty-four hour period. Other conditions can be that the consumer may not send an advertisement with a text message unless a certain number of text messages have been sent that user within a period of time, for example, ten text messages received in 72 hours. If the user violates these rules, the user will be given a warning and if the user continues to violate the rules after a selected period of time such as one or two days, then the user's mobile software application will be cancelled.

A system will be put in place such as warning an advertiser that they must have a certain minimum balance in the account to pay for the advertisements that they have acquired and advising the advertiser if their balance has fallen below a certain amount or percentage of the required funding. The system will provide the webmaster and system operator with the opportunity to postpone advertisements if the advertiser's balance is less than a certain amount. If the advertiser continues to violate the rules, then their advertisements will be dropped.

Therefore, through the present invention apparatus and method, the hardware and software facilitate downloadable mobile software applications which are incorporated into extra reward and gifts without having to do anything different than they are ordinarily doing in operating and text messaging with their portable electronic device. Advertisers are also given an opportunity to specifically focus on the group that will most likely advertise their system.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

What is claimed is:

1. A computer-implemented method comprising:
receiving at a computing device of a first user content provided by a content provider;
determining that the first user has instructed the computing device to transmit a first mobile messaging service message to a device of a second user, the first mobile messaging service message including a message entered by the first user, the message entered by the user including alphanumeric characters,
wherein the message entered by the first user does not include the content from the content provider;
determining if the computing device of the first user has transmitted a first threshold number of mobile messaging service messages to the device of the second user and if the computing device of the first user has received a second threshold number of mobile messaging service messages from the device of the second user in response to one or more of the mobile messaging service messages transmitted to the device of the second user;
at least partly in response to determining that the computing device has transmitted the first threshold number of mobile messaging service messages to the device of the second user and has received the second threshold number of mobile messaging service messages from the device of the second user:
causing, at least in part, the first mobile messaging service message to automatically include the content from the content provider with the message entered by the first user, such that when the first mobile messaging service message is received by the device of the second user the content from the content provider is displayed in association with the message entered by the first user when displayed on the device of the second user.

2. The method of claim 1, the method further comprising:
determining demographic information of the first user; and
selecting, at least partly in response to the determined demographic information, the content provided by the content provider from a plurality of content provided by the content provider for inclusion in the first mobile messaging service message.

3. The method of claim 1, further comprising:
including the content in each of the first threshold number of mobile messaging service messages that are transmitted to the device of the second user; and
causing the content included in each of the first threshold number of mobile messaging service messages not to be displayed in association with the message entered by the first user when the message entered by the first user is displayed on the device of the second user.

4. The method of claim 1, wherein the content provided by a content provider is receiving at the computing device of a first user via an application installed on the computing device of the first user.

5. The method of claim 1, wherein the first mobile messaging service message is an MMS message.

6. The method of claim 1, the method further comprising:
tracking a number of items of content provided by one or more content providers that are automatically included in mobile messaging service messages transmitted from the computing device of the first user to devices of other users, such that when the mobile messaging service messages are received by the devices of the other users items of contents are displayed in association with the message in which they were automatically included; and
generating a report indicating the number of items of content provided by one or more content providers that are transmitted via mobile messaging service messages from the computing device of the first user.

7. The method of claim 1, the method further comprising:
tracking a number of items of content provided by one or more content providers that are automatically included in mobile messaging service messages that are transmitted within a first period of time from the computing device of the first user to devices of other users, such that when the mobile messaging service messages are received by the devices of the other users items of contents are displayed in association with the message in which they were automatically included;
determining whether the number of items of content provided by one or more content providers that are transmitted via mobile messaging service messages from the computing device of the first user within the first period of time at least meets a threshold; and
at least partly in response to determining that the number of items of content provided by one or more content providers that are transmitted via mobile messaging service messages from the computing device of the first user within the first period of time at least meets the threshold, inhibiting content from one or more content providers from being included in mobile messaging service messages from the computing device of the first user for a second period of time.

8. The method of claim 1, wherein the first mobile messaging service message further causes the content from the content provider to be displayed on the device of the second user adjacent to, and below the message entered by the first user.

9. The method of claim 1, wherein the content from the content provider includes at least a video file.

10. The method of claim 1, the method further comprising, causing a graphic separator to be displayed on the device of the second user when the message entered by the first user is displayed on the device of the second user, wherein the graphic separator visually separates the content from the content provider from the message entered by the first user.

11. The method of claim 1, the method further comprising, causing, at least in part, the content from the content provider and the message entered by the first user to be displayed within a same short message graphic frame when displayed on the device of the second user.

12. A computer implemented method, comprising:
installing an application on a mobile computing device of a first user;
determining that the first user has instructed the application, installed on the device of the first user, to transmit a first mobile messaging service message to a device of a second user, the first mobile messaging service message including a message entered by the first user into the device of the first user;
causing, at least in part, the first mobile messaging service message to automatically include content provided by a content provider to the device of the first user with the message entered by the first user;
(i) wherein the message entered by the first user does not include the content from the content provider; and
(ii) wherein the first mobile messaging service message causes the content from the content provider to be displayed on the device of the second user in a messaging visual frame in association with the message entered by the first user.

13. The method of claim 12, the method further comprising:
determining demographic information of the first user; and
selecting, at least partly in response to the determined demographic information, the content provided by the content provider from a plurality of content provided by the content provider for inclusion in the first mobile messaging service message.

14. The method of claim 12, wherein the first mobile messaging service message is an SMS message or an MMS message.

15. The method of claim 12, the method further comprising:
tracking a number of items of content provided by one or more content providers that are automatically included in mobile messaging service messages transmitted from the computing device of the first user to devices of other users, such that when the mobile messaging service messages are received by the devices of the other users items of contents are displayed in association with the message in which they were automatically included; and
generating a report indicating the number of items of content provided by one or more content providers that are transmitted via mobile messaging service messages from the computing device of the first user.

16. The method of claim 12, the method further comprising:
tracking a number of items of content provided by one or more content providers that are automatically included in mobile messaging service messages that are transmitted within a first period of time from the computing device of the first user to devices of other users, such that when the mobile messaging service messages are received by the devices of the other users items of contents are displayed in association with the message in which they were automatically included;
determining whether the number of items of content provided by one or more content providers that are transmitted via mobile messaging service messages from the computing device of the first user within the first period of time at least meets a threshold; and
at least partly in response to determining that the number of items of content provided by one or more content providers that are transmitted via mobile messaging service messages from the computing device of the first user within the first period of time at least meets the threshold, inhibiting content from one or more content providers from being included in mobile messaging service messages from the computing device of the first user for a second period of time.

17. The method of claim 12, wherein the first mobile messaging service message further causes the content from the content provider to be displayed on the device of the second user adjacent to, and below the message entered by the first user.

18. The method of claim 12, wherein the first mobile messaging service message further causes a graphic separator to be displayed on the device of the second user, the graphic separator visually separating the content from the content provider from the message entered by the first user when displayed on the device of the second user.

19. The method of claim 12, wherein the mobile messaging visual frame includes a bubble frame or a rectangular frame.

20. A communication system, comprising:
at least one computing device;
a non-transitory computer-readable medium having computer-executable instructions stored thereon that, when executed by the at least one computing device, cause the at least one computing device to perform operations comprising:
receiving at a computing device of a first user content provided by a content provider;
detecting that a first user has instructed a computing device associated with the first user to transmit a first mobile messaging service message to a device of a second user, the first mobile messaging service message including a message entered by the first user, the message entered by the user including alphanumeric characters, wherein the message entered by the first user does not include the content from the content provider;
determining if the computing device of the first user has transmitted a first threshold number of mobile messaging service messages to the device of the second user and if the computing device of the first user has received a second threshold number of mobile messaging service messages from the device of the second user in response to one or more of the mobile messaging service messages transmitted to the device of the second user;
at least partly in response to determining that the computing device has transmitted the first threshold number of mobile messaging service messages to the device of the second user and has received the second threshold number of mobile messaging service messages from the device of the second user:
automatically causing the first mobile messaging service message to include the content from the content provider with the message entered by the first user, such that when the first mobile messaging service message is received by the device of the second user, the content from the content provider is displayed in association with the message entered by the first user when displayed on the device of the second user, wherein the content from the content provider is displayed adjacent to, but visually separated from the message entered by the first user.

21. The system of claim 20, the operations further comprising:
determining demographic information of the first user; and
selecting, at least partly in response to the determined demographic information, the content provided by the content provider from a plurality of content provided by the content provider for inclusion in the first mobile messaging service message.

22. The system of claim 20, wherein the first mobile messaging service message is an SMS message or an MMS message.

23. The system of claim 20, the operations further comprising:
tracking a number of items of content provided by one or more content providers that are automatically included in mobile messaging service messages transmitted from the computing device of the first user to devices of other users, such that when the mobile messaging service messages are received by the devices of the other users items of contents are displayed in association with the message in which they were automatically included; and
generating a report indicating the number of items of content provided by one or more content providers that are transmitted via mobile messaging service messages from the computing device of the first user.

24. The system of claim 20, the operations further comprising:
tracking a number of items of content provided by one or more content providers that are automatically included in mobile messaging service messages that are transmitted within a first period of time from the computing device of the first user to devices of other users, such that when the mobile messaging service messages are received by the devices of the other users items of contents are displayed in association with the message in which they were automatically included;
determining whether the number of items of content provided by one or more content providers that are transmitted via mobile messaging service messages from the computing device of the first user within the first period of time at least meets a threshold; and
at least partly in response to determining that the number of items of content provided by one or more content providers that are transmitted via mobile messaging service messages from the computing device of the first user within the first period of time at least meets the threshold, inhibiting content from one or more content providers from being included in mobile messaging service messages from the computing device of the first user for a second period of time.

25. The system of claim 20, the operations further comprising, causing a graphic separator to be displayed on the device of the second user when the message entered by the first user is displayed on the device of the second user, wherein the graphic separator visually separates the content from the content provider from the message entered by the first user.

26. The system of claim 20, wherein the content from the content provider and the message entered by the first user are displayed within a mobile messaging visual frame.

27. A non-transitory computer-readable medium having computer-executable instructions stored thereon that when executed by a mobile computing device of a first user, cause the mobile computing device to perform operations comprising:
determining that the first user has instructed application, installed on the mobile computing device of the first user, to transmit a first mobile messaging service message to a device of a second user, the first mobile messaging service message including a message entered by the first user into the device of the first user;
causing, at least in part, the first mobile messaging service message to automatically include content provided by a content provider to the device of the first user with the message entered by the first user;
(i) wherein the message entered by the first user does not include the content from the content provider; and
(ii) wherein the first mobile messaging service message causes the content from the content provider to be displayed on the device of the second user adjacent to, but visually separated from the message entered by the first user.

28. The non-transitory computer-readable medium of claim 27, the operations further comprising:
tracking a number of items of content provided by one or more content providers that are automatically included in mobile messaging service messages that are transmitted within a first period of time from the computing device of the first user to devices of other users, such that when the mobile messaging service messages are received by the devices of the other users items of contents are displayed in association with the message in which they were automatically included;
determining whether the number of items of content provided by one or more content providers that are transmitted via mobile messaging service messages from the computing device of the first user within the first period of time at least meets a threshold; and
at least partly in response to determining that the number of items of content provided by one or more content providers that are transmitted via mobile messaging service messages from the computing device of the first user within the first period of time at least meets the threshold, inhibiting content from one or more content providers from being included in mobile messaging service messages from the computing device of the first user for a second period of time.

29. The non-transitory computer-readable medium of claim 28, the operations further comprising, causing the content from the content provider to be displayed on the device of the second user adjacent to, and below the message entered by the first user.

30. The non-transitory computer-readable medium of claim 28, the operations further comprising, causing, a graphic separator to be displayed on the device of the second user, the graphic separator visually separating the content from the content provider from the message entered by the first user when displayed on the device of the second user.
